(19) United States
(12) Patent Application Publication
(10) Pub. No.: US 2009/0006613 A1
(43) Pub. Date: Jan. 1, 2009

(54) System and a method for updating a user presence status on a terminal by aggregating multisource information

(75) Inventors: Francois Toutain, Louannec (FR); Philippe Bouille, Pleumeur Bodou (FR); Guillaume Collin, Goudelin (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 12/154,366

(22) Filed: May 22, 2008

(30) Foreign Application Priority Data
May 24, 2007 (FR) 0755245

(51) Int. Cl. G06F 15/173

(52) U.S. Cl. 709/224

(57) ABSTRACT

A method of updating a user presence status at at least one terminal connected to a telecommunications network, on the basis of presence status information provided by at least one status source of said terminal. The presence status is determined during an aggregation step comprising collecting a plurality of unit presence probability values provided by a plurality of status sources associated with said terminal; and calculating an aggregated presence status probability resulting from a linear combination of said unit presence probability values.

### FIELD OF THE INVENTION

The present invention lies in the field of digital interpersonal communications and it relates more particularly to managing “presence” information serving to characterize the presence of a user at one or more terminals connected to at least one telecommunications network.

### BACKGROUND OF THE INVENTION

Below, the term “user presence information” is used to designate information about the “physical” presence of the user at a terminal, as contrasted to “network” presence which relates to whether the terminal is connected with the network. User presence information being that the user is genuinely physically close to one or more terminals and that the user is consequently physically available and can be reached. For example, the information may specify that the user is ready to receive a communication on a given terminal, on the contrary that the user is not reachable since already engaged on a communication. This presence status is transmitted via the network so as to be available for consultation by other users and/or automatic applications implemented by the network, which can therefore take account of the presence status of that particular user.

In the present state of knowledge, various mechanisms are in use for managing presence status in order to determine the presence status of a user at a terminal.

A first solution consists in using a declarative presence mechanism whereby the user takes steps to define presence or absence. This applies in particular to presence mechanisms implemented in the context of instant messaging systems, where the user specifies whether or not he or she is present by selecting at all times one particular presence status from a set of predefined presence statuses, the selected status being displayed and possibly associated with content that the user is free to add, such as a string of characters or a text message or an icon.

Nevertheless, that solution is left entirely to the initiative of the user, so it constitutes a method that is not reliable and that the user can find tedious to comply with insofar as the user is required to update a presence status manually each time status changes. In the particular circumstances of a user being called on to leave a terminal frequently, the user would need to update the presence status each time he or she leaves or rejoins the terminal.

A second solution consists in observing the general activity of the physical system containing the presence management system. When the presence management system is software running on a physical system, e.g. constituted by a computer, it is possible to use a computer operating system to obtain relatively raw information about the level of activity of the user on the computer. For example keystroke events, mouse movement events, or physical movements detected by an inertial unit incorporated in the computer make it possible to detect user activity at the terminal.

Furthermore, it is also known from the multiple points of presence (MPOP) concept to manage the presence status of a user possessing multiple terminals on the basis of presence status information provided by those terminals. In particular, the extensible messaging and presence protocol (XMPP) generally implemented in instant messaging systems provides a presence status of the user on the basis of presence status information provided by such terminals. For this purpose, each terminal associates a priority value with the presence status information it provides. The presence status of the user is then obtained by selecting from the set of presence statuses provided by the terminals, that terminal for which the presence status presents the greatest priority value.

Nevertheless, the XMPP protocol does not enable the presence status of a user to be determined in a manner that is reliable over time, it being understood that the presence status of the user is determined merely by arbitration based on a status priority that is selectable by the terminal.

In general, the above-described solutions, even when used together, provide presence information that is no more than the connection status of the user's terminal (network presence information) and does not constitute information that is reliably representative of the user being physically present.

The tediousness of the user manually updating a presence status means that in practice users do not update presence information regularly. As a result, the presence information displayed by the presence management system is generally not reliable. Increased reliability would require the user to update this information regularly, which is time consuming and unattractive to the user.

### OBJECTS AND SUMMARY OF THE INVENTION

In accordance with one aspect, the present invention provides a solution that avoids the above-mentioned drawbacks, by proposing a method of updating a presence status concerning a user on at least one terminal connected to a telecommunications network, with this being done on the basis of presence status information that is provided by at least one status source of said terminal.

In accordance with one aspect of the present invention, a user presence status is determined during an aggregation step comprising:

collecting a plurality of unit presence probability values provided by a plurality of status sources associated with said terminal; and

calculating an aggregated presence status probability resulting from a linear combination of said unit presence probability values.

Taking account of a plurality of unit presence probability values by calculating an aggregated presence probability makes it possible to obtain information characterizing the presence status of the user at a given terminal in a manner that is reliable.

According to a characteristic of the invention, during the aggregation step, the unit presence probability values are classified by increasing order, so as to provide an ordered set of values, prior to being used for calculating the aggregated presence status probability.

This classification by increasing order makes it possible to optimize calculating the aggregated presence status probability by maximizing said probability value.

According to another characteristic of the invention, said aggregated presence status probability associated with said terminal is defined by P=Mₙ calculated by recurrence using the following formula:

Mᵢ=Mᵢ₋₁+0.5×(Vᵢ−Mᵢ₋₁)

for all 1≦i≦n, and with the initial condition M₀=0.5, where Vᵢ designates the i^{th} unit presence probability value taken in said ordered set, and n designates the last element of said ordered set.

This recurrence formula makes it possible to maximize the aggregated presence probability value, while also maximizing the reliability of the presence status information about the user.

According to another characteristic of the invention, the presence status of the user is determined from the aggregated presence status probabilities relating to a plurality of terminals of the user connected to the network, in such a manner as to determine the terminal at which the user has the greatest probability of being found.

Taking account of presence information obtained from a plurality of terminals concerning the same user makes it possible to further improve the reliability of the information relating to the presence status of that user.

According to another characteristic of the invention, the presence status information units are provided dynamically in response to the user being interrogated by at least one status source associated with a terminal of the user.

The user providing presence information, in response to periodic interrogation carried out by at least one status source, makes it possible to maintain over time information relating to the presence status of that user and that is reliable over time. The calculation of the invention is performed on the basis of information that is collected regularly, thus making it possible to maintain in reliable and optimum manner the pertinence of the presence status information about a user on one or more terminals.

One aspect of the invention also provides a system for updating a presence status of a user at at least one terminal connected to a telecommunications network, each terminal being associated with at least one status source for providing presence status information about said user.

The system includes a data aggregation device comprising:
collector means for collecting a plurality of unit presence probability values provided by a plurality of status sources associated with the terminal; and
calculator means for calculating an aggregated presence status probability resulting from a linear combination of the unit presence probability values.

The advantages and particular embodiments of the invention are the same as those associated with the method of the invention, as described above.

According to another characteristic of the invention, the calculator means are adapted to calculate the aggregated presence status probability defined by P=Mₙ associated with said terminal by recurrence using the formula:

Mᵢ=Mᵢ₋₁+0.5×(Vᵢ−Mᵢ₋₁)

for all 1≦i≦n, with the initial condition M₀=0.5 and n designating the last element of said ordered set; where Vᵢ designates the i^{th} unit presence probability value taken in said ordered set.

The various steps of the method can be implemented by computer program instructions.

Consequently, an aspect of the invention also provides a computer program comprising instructions for executing the steps of the above-described method of the invention, when the program is executed by a computer.

The program can make use of any programming language and can be in the form of source code, object code, or a code intermediate between source code and object code, such as in a partially compiled form, or in any other desirable form.

One aspect of the invention also provides a recording medium readable by a computer and on which there is recorded a computer program comprising instructions for executing the steps of the above-described method of the invention.

The information medium may be any entity or device capable of storing a program. For example, the medium may comprise storage means such as a read-only memory (ROM), e.g. a CD-ROM or a mircoelectronic circuit ROM, or indeed a magnetic recording medium, such as a floppy disk or a hard disk.

Furthermore, the data medium may be a transmissible medium, such as an electrical or an optical signal, that may be conveyed by an electrical or optical cable, by radio, or by other means. The program of the invention may in particular be downloaded from an Internet type network.

Alternatively, the information medium may be an integrated circuit in which the program is incorporated, the circuit being adapted to execute the method of the invention or to be used in the execution of the method of the invention.

### BRIEF DESCRIPTION OF THE DRAWINGS

Other characteristics and advantages of the invention appear from the following description of embodiments given as non-limiting examples and with reference to the accompanying drawings, in which:

FIG. 1 is a diagram showing a system including an aggregation device of an embodiment of the present invention;

FIG. 2 is a diagram showing an embodiment of the aggregation device;

FIG. 3 is a flow chart showing the steps of the method of updating a presence status of a user in accordance with one embodiment of the present invention; and

FIG. 4 is a diagram showing an embodiment of the system for updating a presence.

### DETAILED DESCRIPTION OF THE DRAWINGS

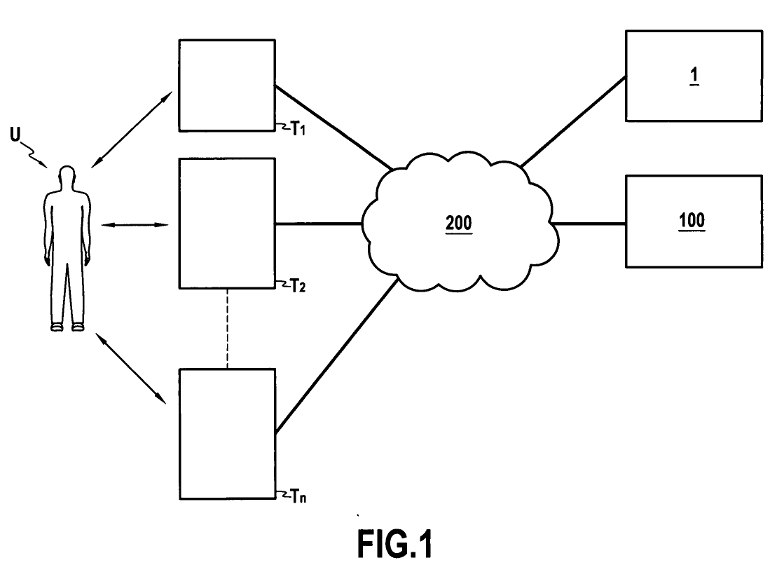

The present invention applies in general when a user U possesses a plurality of terminals T₁, . . . , Tₙ connected to a telecommunications network 200, as shown in FIG. 1.

An aggregation device 100 of the invention, referred to below as an aggregator 100, is connected to the network 200 so as to communicate with the plurality of terminals T₁, . . . , Tₙ of the user and with an application executed on a server 1. In known manner, each terminal T of the plurality of terminals T₁, . . . , Tₙ of the user U includes a network interface adapted to communicate with the aggregator 100 via the network 200.

The terminal T may be selected from any of the following devices: a computer; a personal digital assistant (PDA); a fixed telephone terminal; a mobile telephone terminal (GSM, UMTS); or any other type of terminal capable of connecting to the network 200.

The network 200 relates in general to a communications network that enables digital data to be transmitted between the aggregator 100 and the user terminals. By way of example, the network 200 may be selected from any of the following networks: an integrated services digital network (ISDN); an IP packet switching network; or a wireless cellular telephone network (GSM, UMTS).

A server 1 executing a user application is suitable for communicating with the aggregator 100 via the network 200.

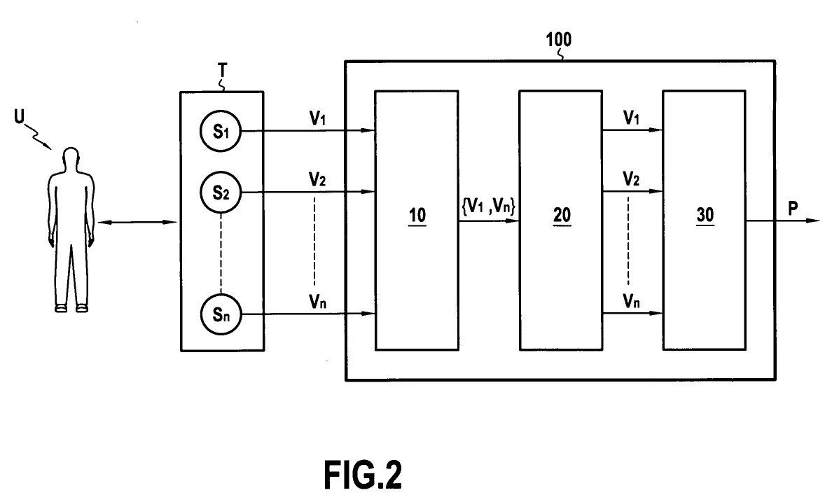

An embodiment of the invention is described below more precisely with reference to FIG. 2 so as to determine the presence status of a user U at any communications terminal T.

Status Source

As shown in FIG. 2, a plurality of status sources {Sᵢ}_{1≦i≦n}, written S₁, . . . , Sₙ, are associated with the terminal T of the user U. By definition, the term “status source Sᵢ” is used to designate in general terms software and/or hardware means or a computer process enabling at least one of the following operations to be performed:
generating information about the presence status of user U at the terminal T with which said status source Sᵢ is associated; and
communicating said information about the presence status to the aggregator 100 of the invention via the network 200.

To simplify, the network 200 is not shown in FIG. 2, but naturally, as described above, the terminal T communicates with the aggregator 100 via the network 200 so as to communicate information about presence status to the aggregator 100.

A status source Sᵢ associated with the terminal T of the user U may be constituted, for example, by any one of the following processes:
a declarative updating process performed by the user U by means of a presence client enabling the user U to define explicitly the user's presence status at the terminal T, which declaration may be made alternatively on a third-party interface provided on a web site or a voice portal;
a process that observes the activity of the user U on the terminal T on which the process is executed, this process being for example a process for monitoring peripherals (keyboard, mouse, webcam or any other type of peripheral) making it possible to detect activity of the user U on the terminal T;
a process of detecting movement that is embedded in the terminal T and that makes it possible to detect movement of the user U when the terminal T is a portable or mobile terminal, such detection being performed, for example, by means of a movement supervisor making use of an inertial unit;
a process of monitoring the connectivity of the terminal T with a wireless network, said process being capable of detecting a change in the connectivity status of the terminal T representative of movement of the user U (e.g. by making use of information relating to “roaming” operations in a cellular network, such as terminal entry or exit events, e.g. events of the terminal entering/exiting a GSM or UMTS network cell; events involving entering or leaving radio range of a WiFi™ or Bluetooth network);
a process of detecting and analyzing proximity implemented by personal identification equipment, e.g. constituted by a radio frequency identification (RFID) receiver associated with the terminal T, the RFID receiver being suitable for detecting the proximity of an identifier worn by the user U and for analyzing dynamically any changes of status (e.g. detecting that the user U has moved away from the RFID receiver);
a process of detecting extended activity by interfacing with sensors of the home automation type, capable of determining the physical presence of a user U by using physical sensors positioned in a premises (e.g. detecting and analyzing data provided by: a volume-measuring presence sensor; an infrared wave sensor; a webcam or a surveillance camera; a pass counter; a door-opening detector; etc. . . . );
a process of explicitly questioning the user U enabling the user to declare his or her presence to the terminal T via a man/machine interface (MMI) request, which question is addressed periodically to the user U;
a method of making use of diary type data of the kind found in Google Calendar or Outlook Express, making it possible to predict the activity of the user U; and
an active interrogation method acting between various pieces of equipment for obtaining information about the presence status of the user U, such as a method of exchange via a Bluetooth channel between the user's mobile terminal T and the computer on board a vehicle, the exchange serving to determine whether the user U is driving, in which case it is deduced that the user U is not available to answer a telephone call on the mobile terminal T.

Each status source Sᵢ is suitable for delivering raw or “basic” information about user presence status, such as presence status information units constituted by unit presence probabilities Vᵢ, these probabilities being obtained from the processes described below.

Optionally, each presence status information unit Vᵢ can be associated with category type information Kᵢ, e.g. relating to the mood, the location, or the activity of the user U. In this way, the presence status of the user U takes account of additional parameters that the user U can configure, thus making it possible to give information about the user's desire or genuine ability to be contacted or to answer a call.

This information is accompanied by an identifier IDᵢ of the terminal T serving to specify the terminal to which the status determination process and consequently to which the presence status information applies. This identifier IDᵢ of the terminal may be static information, such as the medium access control (MAC) address of the terminal's network interface, the mobile station integrated service digital network (MSISDN) telephone number, or the session initiation protocol—uniform resource identifier (SIP-URI) identifier associated with the terminal.

Furthermore, any presence status information is delivered with a confidence value Cᵢ that expresses the probability that this status is true. For example, a confidence value Cᵢ equal to 100% indicates that the user is certainly close to the status source Sᵢ.

Finally, the presence status information delivered by a status source Sᵢ is associated with a time stamp Zᵢ such that statuses can be ordered in time for subsequent analysis.

Aggregator

The aggregator 100 used in the invention constitutes a point where presence status information communicated by the various status sources S₁, . . . , Sₙ is brought together and processed so as to provide an aggregated presence status probability P, this probability P being calculated as a function of the presence status information units delivered by all of the status sources S₁, . . . Sₙ.

The aggregator 100 can be implemented for example within a presence server adapted to receive connections from the various status sources Sᵢ.

As shown in FIG. 2, the aggregator 100 of the invention comprises:
collector means 10 for collecting a plurality of unit presence probability values V₁, . . . , Vₙ delivered by the status sources S₁, . . . , Sₙ associated with the terminal T, these values being transmitted via the network 200 (not shown);
classifier means 20 for classifying the unit presence probability values V₁, . . . , Vₙ in increasing order, so as to form an ordered set E={V₁, . . . , Vₙ} of unit presence probability values, these values being for use in calculating the aggregated presence status probability (P); and
calculator means 30 for calculating the aggregated presence status probability (P), resulting from a linear combination of unit presence probability values {V₁, . . . , Vₙ} classified by increasing order of the ordered set E.

In known manner, the connector means 10, the classifier means 20, and the calculator means 30 of the aggregator 100 are constituted by software means implemented on a microprocessor associated with a random access memory (RAM) and/or ROM system.

The aggregator 100 thus makes it possible to maintain a user presence status for each terminal, with an aggregated presence probability. In order to maintain a reliable presence status over time, the collector means 10 of the aggregator 100 are adapted, where necessary, to interrogate a status source Sᵢ in order to refresh the presence status of the user.

More specifically, the aggregator 100 has means for keeping up to date a presence table in which all of the terminals of each user are identified in association with presence information. By way of example, these updater means are constituted by software means implemented on a microprocessor associated with a RAM and/or ROM memory system.

For each terminal, the presence table stores an aggregated presence probability relating to the presence of the user at that terminal, together with a sub-table describing all of the status sources associated with the terminal. For each of the status sources, at least the following information is conserved in the sub-table:
the most recent unit presence status probability transmitted by each source; and
the date/time of the most recent transmission of each unit presence status probability.

Determining an Aggregated Presence Status

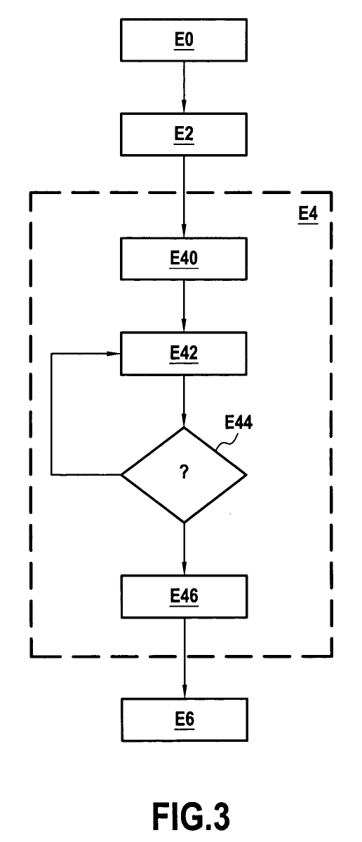

The aggregated probability of a user U being present at a terminal T is determined by the aggregator 100 of the invention in a manner that is described in detail below with reference to FIGS. 2 and 3. For each terminal T, the aggregated presence probability P is calculated by the aggregator 100 using the following steps.

During an initial collection step E0, the aggregator 100 of the invention uses the collector means 10 to obtain unit presence status probability values Vᵢ as provided by each status source Sᵢ associated with terminal T.

It should be observed that the provision of presence status information by a status source Sᵢ to the aggregator 100 of the invention can be performed using any of the following modes:
asynchronously, whenever the status source Sᵢ observes a change in the presence status information Vᵢ;
periodically, if the status source Sᵢ operates periodically; or
on request, i.e. in response to a request from the aggregator 100 desiring updating of the presence status information Vᵢ.

An explicit interrogation of the status source Sᵢ is performed by the collector means 10 of the aggregator 100, in the event that the status source Sᵢ does not supply its status spontaneously. Under such circumstances, the aggregator 100 polls the status source Sᵢ periodically or on request.

The aggregator 100 can also interrogate the status source Sᵢ when the presence status stored in the presence table held by the aggregator 100 does not make it possible to obtain a satisfactory response to a request issued by a third-party application. This happens for example when the reliability required in the request is greater than the aggregated presence probability. In the context of an emergency call service, a call must get through immediately, which is why an emergency call server issues calls only to users who are highly rechargeable, i.e. who present an aggregated presence probability greater than some threshold required by the service.

During a classification step E2, the classifier means 20 of the aggregator 100 classify the unit presence probability values V₁, . . . , Vₙ in increasing order so as to provide an ordered set E={V₁, . . . , Vₙ} that is subsequently used for calculating the aggregated presence status probability P.

During a calculation step E4, the aggregated presence probability value P is calculated for each terminal T as a function of the unit presence probability Vᵢ provided by each status source Sᵢ. To do this, the calculator means 30 of the aggregator 100 calculate the aggregated presence status probability P=Mₙ using the following recurrence formula:

Mᵢ=Mᵢ₋₁+0.5×(Vᵢ−Mᵢ₋₁) [Eq. 1]

with the initial condition M₀=0.5 and for all natural integers i such that 1≦i≦n, where n is a non-zero integer designating the last element of the set E such that Vₙ=Max(E) and Vᵢ is a unit status presence probability provided by a status source designating the i^{th} value taken in said ordered set E of values sorted in increasing order.

During an initialization substep E40, the calculator means 30 perform the initialization step M₀=0.5 corresponding to the initial condition of the recurrence formula (Eq. 1).

During a calculation substep E42, the calculation means 30 apply the recurrence formula Eq. 1 so as to calculate:

M₁=M₀=0.5×(V₁−M₀)

from the value M₀ as initialized during the initialization substep E40 and from the unit presence probability V₁ previously obtained during collection step E0.

If elements remain for processing in the ordered set E (if test step E44 is positive), then the calculator means 30 apply the recurrence formula Eq. 1 so as to calculate:

M₂ =M₁+0.5×(V₂−M₁)

from the value M₁ previously calculated during calculation step E42 (preceding iteration) and from the unit presence probability value V₂ obtained during the collection step E0.

The calculation step E42 and the test step E44 are reiterated so long as there remain elements to be processed in the ordered set E, i.e. so long as the index i remains less than the number n.

When i=n, the calculator means perform the following calculation:

Mₙ=Mₙ₋₁+0.5×(Vₙ−Mₙ₋₁)

from the previously calculated values Vₙ and Mₙ₋₁. Once all of the elements of the ordered set E have been processed (i>n) by the calculator means 30, the aggregated presence probability P=Mₙ has been obtained (final substep E46).

It should be observed that the calculation step E4 is performed by the calculator means 30 after the steps E0 and E2 of collecting and classifying the unit probability value Vᵢ, and in response to any of the following events:
on receipt by the collection means of a new presence information unit Vᵢ from a status source Sᵢ; and
on receipt by the aggregator 100 of a request for which the aggregator presence probability P is considered as being insufficiently accurate or insufficiently reliable, in which case calculation step E4 is executed after interrogating all or some of the status sources and updating from those sources during collection step E0. If the previously calculated value is below the accuracy threshold specified in the request, then an explicit interrogation of the sources may be performed followed by a new calculation.

It should be observed that the unit probability values are classified by increasing order during classification step E2 prior to performing calculation step E4, it being understood that calculation using above formula Eq. 1 is an operation that is not commutative and that by convention it is desired to maximize presence probability. Since the calculation operation is not commutative, classifying unit presence probabilities guarantees results that are consistent and mutually comparable. In this example, classification by increasing order is used, which gives rise to presence probability values that are greater that would have been obtained by classification in decreasing order.

For each terminal T, the presence probability values aggregated by the above formula makes it possible to ensure that the result remains normalized such that 0≦P≦1.

Communication Between the Status Sources and the Aggregator

The status sources S₁, . . . , Sₙ communicate with the aggregator 100 in computerized manner that can be implemented on any network using appropriate transport protocols.

For example, on an IP network, session initiation protocol (SIP) can be used, making use of non-connected mode made possible by exchanging messages of the MESSAGE type. Alternatively, a subscribe/notify type mechanism can also be used as made possible by SUBSCRIBE/NOTIFY messages.

Another protocol could be XMPP (Jabber) which makes use of a similar mechanism (“pubsub”). Under such circumstances, and generally, the messages required are as follows:
a message sent by the aggregator 100 to the status sources to request communication of an updated presence status; and
a message sent by a status source to the aggregator 100, to communicate an updated presence status.

The presence status information provided by the aggregator 100 of the present invention can be transmitted to an application capable of making use thereof. By way of example, such an application is performed by the server 1 communicating with the aggregator 100 via the network 200 described in FIG. 1. Examples of such applications are described below.
Dynamic address book (DAB): information determining the presence of a contact in a dynamic address book can be refreshed on consulting the detailed entry for the contact, or on an explicit request of the user.
Push service of the “Live info service” type: a content server “pushes” update information to the user. To improve this service, it is desirable for the terminal that receives the information to be the terminal for which the user presence probability is the greatest. The service may also be parameterized by the user, e.g. defining a list of terminals on which the user desires to receive this content. The server then obtains presence information from each of the terminals in the list, said information being provided by the aggregator 100 of the present invention.
On-line gaming services of the “Multiplayer gaming” type: a massively multiplayer game in a persistent universe can be called on to notify a player of an important event that requires intervention by the player. It is advantageous for this notification to take place on the terminal where the presence of the user is the most probable.
A call routing service: in association with a reachability service, the idea is to send a call to the terminal where the called party is the most likely to reply.
An advertising service of the “targeted advertising” type. This is an analogous “Live info service” application, the advertising service seeking to maximize the impact of advertising while minimizing the inconvenience to the user. For this purpose, an advertising content server seeks to optimize the sending of information to the most appropriate terminal, i.e. the terminal where the targeted user is to be found. This avoids non-targeted sending that gives rise to inconvenience, particularly when terminals are shared between a plurality of users (e.g. personal computers (PCs)).
Dating services. This type of service can make use of the presence information provided by the aggregator 100 of the invention in order to optimize putting two members into communication with each other. For example, new subscribers may desire to communicate their own profiles to other members providing those other members are reachable (in order to filter “inactive” contacts, even if one or the other of the parties decides in the end not to proceed).
An emergency call service where it is necessary to locate the person for whom an emergency call is intended as accurately and as quickly as possible. For this purpose, the aggregator 100 of the invention makes it possible to determine in reliable manner which terminal presents the highest probability of the called party being reachable.
Personal surveillance service, for notifying a supervisor when the presence information about the person under surveillance becomes too inaccurate.

Once the aggregator 100 has performed the aggregated presence information calculation, it communicates with a user client application that is going to make use of this information so as to provide a service as described above. Communication between the aggregator 100 and the application is likewise of the computer type, and can make use of the protocols that are mentioned above. It is of the request/response type, with messages defined in general manner as follows:
the request message is sent by the application making a request about the presence status of a user. In general, this request asks to be provided with a list of user terminals ordered by decreasing probability of presence, and associated with the probability of presence at each terminal. In addition, the request includes a minimum reliability level required by the requesting party. The request may be used for several types of need, such as:
requesting which terminal presents the greatest reliability of the user being present, with an indication of the minimum probability required;
requesting the reliability level of presence at a given terminal, together with a maximum threshold; and
selecting a subset of terminals amongst the user's terminals in order to maximize the chances of reaching the user.

The response message comprises a list ordered by decreasing probability for the user's terminals, with mention of each presence probability. The aggregator of the invention serves to maximize the reliability of the information, and it makes use of the minimum level specified by the client when deciding whether or not to interrogate the status sources in explicit manner.

### FIRST EXAMPLE

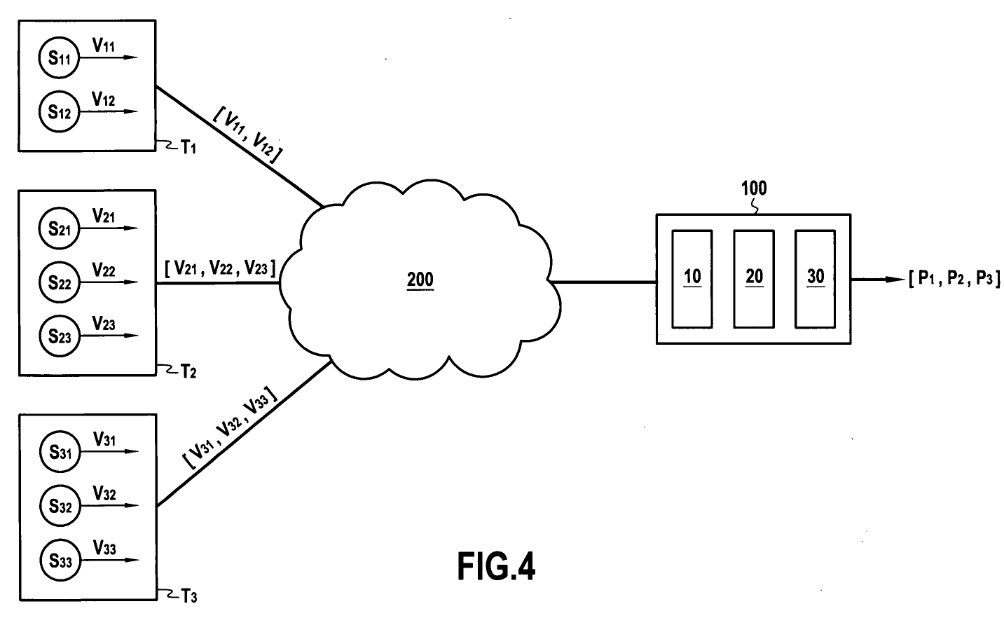

A first example of providing and using the invention is given below in detail with reference to FIG. 4. In this example, it is assumed that the user U has three terminals:
a fixed terminal T₁ at home;
a dual mode (cell/WiFi) mobile terminal T₂ that the user may carry around or keep nearby; and
a fixed computer T₃ at work.

Each terminal is associated with a plurality of status sources as listed below.

The fixed terminal T₁ of the user U has the following two status sources:
a network presence supervisor S₁₂; and
an RFID detector or scanner S₁₁, the user having an RFID tag that is worn permanently (e.g. in the form of a bracelet or on a neck chain).

The RFID detector S₁₁ is assumed to detect the presence of the RFID tag worn by the user without making contact within a radius of a few meters. The RFID detector S₁₁ generates periodic presence status information indicating whether the user U is or is not within its radio range.

The mobile terminal T₂ of the user U has the following three status sources:
a network presence supervisor S₂₃;
an inertial unit S₂₂ monitoring movement; and
a network roaming supervisor S₂₁.

Network presence supervision is provided by the operator network. This generates a presence status indication as soon as the mobile terminal T₂ registers with the network (together with the identity of the user), or on the contrary when the mobile terminal T₂ unregisters.

The inertial unit type server S₂₂ embedded in the mobile terminal T₂ generates an updating event on detecting movement of the mobile terminal T₂ (probably using a hysteresis mechanism to limit the number of updates over time).

The network roaming supervisor S₂₁ generates an updating event on detecting a change of status associated with the connectivity of the mobile terminal T₂. For example, a change of status is detected when the mobile terminal T₂ changes cell in a cellular network or when it moves into WiFi range and connects to a WiFi network.

The computer T₃ of the user has the following three status sources:
an explicit declaration module S₃₃ concerning the presence status of the user U;
an activity supervisor S₃₂ monitoring user activity via the peripherals of the computer (keyboard, mouse); and
a supervisor S₃₁ associated with a webcam integrated in the computer screen and capable of detecting a human form in front of the screen.

The module S₃₃ for explicitly declaring the presence of a user at the computer T₃ provides a graphical interface enabling the user U to specify the user's presence status. This module also incorporates an asynchronous request function that interrogates the user dynamically to ask the user to declare the user's presence status at that instant. The ergonomics of the graphical interface are organized so that it enables presence status to be updated as simply and as quickly as possible while disturbing the user as little as possible. This request can be generated theoretically or from time to time at the request of the aggregator 100. Following an interrogation from the aggregator 100, the process decides, on the basis of its internal state, whether it forwards the request to the user via an MMI interrogation request. Thus, the user is interrogated about presence status by the process implemented by the explicit declaration module, without the user being required to update that presence status over time.

The user activity supervisor S₃₂ periodically generates a presence status whenever user activity is detected on the computer T₃. Once this activity is interrupted, the supervisor provides a zero probability update and then stops sending updating messages.

The supervisor S₃₁ associated with the webcam generates, likewise, a periodic presence status so long as a human form is recognized as being in front of the screen of the computer T₃. Furthermore, it modulates the presence probability V₃₁ as a function of the result provided by the visual recognition process (confidence level in recognizing the face or the human form).

Table 1 below shows by way of example the presence status table as maintained by the aggregator 100, as at a particular instant t₁. In the table, there can be seen the current value of the unit presence status probabilities provided by the various presence status sources S₁₁, S₁₂, S₂₁, S₂₂, S₂₃, S₃₁, S₃₂, and S₃₃. The ages of these values are expressed in seconds in the column labeled “Age”.

TABLE 1
Example of the content of the table maintained by the aggregator

| | | | | Normalized |
|---|---|---|---|---|
| | | Current | Age | aggregated |
| Terminal/Status source | | value | (seconds) | presence |
| Fixed | Network presence | V₁₂ = 1 | 3600 | P₁ = 0.625 |
| terminal | supervisor (S₁₂) | | | |
| (T₁) | RFID scanner | V₁₁ = 0 | 55 | |
| | (S₁₁) | | | |
| Mobile | Network presence | V₂₃ = 1 | 600 | P₂ = 0.9375 |
| terminal | supervisor | | | |
| (T₂) | (S₂₃) | | | |
| | Inertial unit | V₂₂ = 1 | 90 | |
| | (S₂₂) | | | |
| | Network roaming | V₂₁ = 1 | 8200 | |
| | (S₂₁) | | | |
| Computer | Explicit declaration | V₃₃ = 1 | 3600 | P₃ = 0.90625 |
| (T₃) | module (S₃₃) | | | |
| | Keyboard/mouse | V₃₂ = 1 | 210 | |
| | activity (S₃₂) | | | |
| | Webcam (S₃₁) | V₃₁ = 0.75 | 35 | |

It can be observed that for each terminal T₁, T₂, T₃ in Table 1, the respective status sources S₁₁, S₁₂; S₂₁, S₂₂, S₂₃; S₃₁, S₃₂, S₃₃ are sorted by increasing presence values for each corresponding terminal T₁, T₂, and T₃. The normalized aggregated presence probability values P₁, P₂, and P₃ for each corresponding terminal T₁, T₂, and T₃ are calculated by the calculation means as descried above, using the following recurrence formula:

Mⱼᵢ=Mⱼᵢ₋₁+0.5×(Vⱼᵢ−Mⱼᵢ₋₁) [Eq. 2]

It should be observed that the above formula written Eq. 2 corresponds to the formula Eq. 1 described above but having an additional index j added thereto to distinguish between the various terminals. In this example, j is a natural integer such that 1≦j≦3 and Mⱼ₀=M₀=0.5.

For the fixed terminal T₁, the aggregated presence probability value is P₁=M₁₂=0.625, where M₁₂ is obtained in accordance with the above-described occurrence formula.

M₁₀=0.5 (initial condition)

M₁₁=0.5×(V₁₁+M₁₀)=0.5×(0+0.5)=0.25 (1st iteration: i=1)

M₁₂=0.5×(V₁₂+M₁₁)=0.5×(0+0.25)=0.625 (2nd iteration: i=2)

Similarly, for the mobile terminal T₂, the aggregated presence probability value is P₂=M₂₃=0.9375.

M₂₀=0.5 (initial condition)

M₂₁=0.5×(V₂₁+M₂₀)=0.5×(1+0.5)=0.75 (1st iteration: i=1)

M₂₂=0.5×(V₂₂+M₂₁)=0.5×(1+0.75)=0.875 (2nd iteration: i=2)

M₂₃=0.5×(V₂₃+M₂₂)=0.5×(1+0.875)=0.9375 (3rd iteration: i=3)

Similarly for the computer T₃, the aggregated presence probability value is P₃=M₃₃=0.90625.

M₃₀=0.5 (initial condition)

M₃₁=0.5×(V₃₁+M₃₀)=0.5×(0.75+0.5)=0.625 (1st iteration: i=1)

M₃₂=0.5×(V₃₂+M₃₁)=0.5×(1+0.625)=0.8125 (2nd iteration: i=2)

M₃₃=0.5×(V₃₃+M₃₂)=0.5×(1+0.8125)=0.90625 (3rd iteration: i=3)

In this example, given the aggregated presence probability, it is probable that:
the user is at the computer T₃ but busy with a task that involves activity on the peripherals (e.g. viewing a document);
the mobile terminal T₂ is probably in reach, since it moved only a few tens of seconds ago; and
however the user is not close to the fixed terminal T₁, as demonstrated by the RFID detector.

### SECOND EXAMPLE

The invention is described below in the context of an application to an emergency call service. In this second example, it is considered that the user application is an emergency call service application referred to as an “emergency call application” that needs to know the terminal(s) at which it can reach the user with a high degree of reliability, in the event of an emergency.

In this second example, in order to simplify, we return to the current status at instant t₁ shown in the presence table described above as Table 1. It is assumed that the emergency call application sends a request to the aggregator 100 asking for the complete list of terminals at which the probability of the user U being present is greater than 95%.

At instant t₁, the aggregated presence statuses for the three terminals T₁, T₂, T₃ are judged to be insufficiently reliable because of the relatively large age values (8600 seconds; 3600 seconds), indicating that some of the status sources have not recently updated their presence status information. As a result, the aggregator 100 sends out interrogations to those sources that can be interrogated, i.e.:
the RFID scanner S₁₁ on the fixed terminal T₁;
the inertial unit supervisor S₂₂ of the mobile terminal T₂;
the network roaming observer S₂₁ of the mobile terminal T₂;
the explicit declaration module S₃₃ of the computer T₃;
the keyboard/mouse activity supervisor S₃₂ of the computer T₃; and
the supervisor S₃₁ associated with the webcam on the computer T₃.

During the above-described collection step E0, the aggregator 100 obtains new unit presence probabilities provided by the various status sources in response to the interrogations sent thereto.

At the end of classification step E2 and calculation step E4 as described above, the aggregator 100 updates its presence table describing the current status at instant t₂>t₁, and as shown in Table 2 below.

TABLE 2
Content of the table in the aggregator when recently updated

| | | | | Normalized |
|---|---|---|---|---|
| | | Current | Age | aggregated |
| Terminal/Status source | | value | (seconds) | presence |
| Fixed | Network presence | V₁₂ = 1 | 3600 | P₁ = 0.625 |
| terminal | supervisor (S₁₂) | | | |
| (T₁) | RFID scanner | V₁₁ = 0 | 0 | |
| | (S₁₁) | | | |
| Mobile | Network presence | V₂₃ = 1 | 600 | P₂ = 0.5625 |
| terminal | supervisor | | | |
| mobile | (S₂₃) | | | |
| (T₂) | Inertial unit | V₂₂ = 0 | 0 | |
| | (S₂₂) | | | |
| | Network roaming | V₂₁ = 0 | 0 | |
| | (S₂₁) | | | |
| Computer | Explicit declaration | V₃₃ = 1 | 0 | P₃ = 0.91125 |
| (T₃) | module (S₃₃) | | | |
| | Keyboard/mouse | V₃₂ = 1 | 0 | |
| | activity (S₃₂) | | | |
| | Webcam (S₃₁) | V₃₁ = 0.75 | 0 | |

From the results provided in Table 2, the following an be observed:
the RFID scanner S₁₁ is not detecting the user U in the proximity of the fixed terminal T₁;
the inertial movement detector S₂₂ of the mobile terminal T₂ finds that the mobile terminal T₂ is not moving;
the network roaming observer S₂₁ of the mobile terminal T₂ is unaware of any recent movement of the mobile terminal T₂;
the explicit declaration module S₃₃ on the computer T₃ has received a positive response from a human user (assumed to be the user registered for the computer T₃);
the keyboard/mouse activity supervisor S₃₂ has detected recent activity (probably due to the explicit request which caused the user to make use of the mouse and/or the keyboard of the computer T₃); and
the detector S₃₁ associated with the webcam recognizes a human form with presence probability of 75%.

From Table 2, the aggregator 100 does not have any terminal that satisfies the required reliability criterion (aggregated presence probability greater than 95%). The aggregator 100 returns the available information to the client application, which can then continue its processing.

On the basis of the results communicated, the emergency treatment application will contact the user, preferably via the computer T₃. The relatively high aggregated presence probability relating to the computer T₃ makes it likely that the user U will indeed be capable of responding to the request. Nevertheless, the requesting application has not been able to obtain an aggregated presence probability that is sufficiently high compared with the threshold specified in the request.

### THIRD EXAMPLE

The present invention can also be applied to a targeted advertising type of application. In this application example, it is assumed that the user is registered with a targeted advertising notification service so as to be informed of promotions or novelties in the user's own fields of interest. An advertiser's information server decides to send such information to the user. The service sets out to be pleasant and useful so it must minimize any inconvenience that might be caused by making contact in untimely manner. For this purpose, the information server contacts the presence service and requests the terminals of the user to be classified by decreasing probability of presence, the classification being provided by the aggregator 100 of the invention.

On the basis of the data known in Table 1, the aggregator 100 responds with the following ordered list: {mobile terminal T₂, computer T₃, fixed terminal T₁}. The advertising service then decides to send its information content by means of an SMS, to the mobile terminal T₂, which is the terminal where the user is the most likely to access the information.

What is claimed is:

1. A method of updating a user presence status at at least one terminal connected to a telecommunications network, on the basis of presence status information provided by at least one status source of said terminal, wherein said presence status is determined during an aggregation step comprising:
collecting a plurality of unit presence probability values provided by a plurality of status sources associated with said terminal; and
calculating an aggregated presence status probability resulting from a linear combination of said unit presence probability values.

2. A method according to claim 1, wherein during the aggregation step, the unit presence probability values are classified by increasing order, so as to provide an ordered set of values, prior to being used for calculating the aggregated presence status probability.

3. A method according to claim 2, wherein said aggregated presence status probability associated with said terminal is defined by P=Mₙ calculated by recurrence using the following formula:
Mᵢ=Mᵢ₋₁+0.5×(Vᵢ−Mᵢ₋₁)
with the initial condition M₀=0.5, where n designates the last element of said ordered set and i is a natural integer such that 1≦i≦n, Vᵢ designating the i^{th} unit presence probability value taken in said ordered set.

4. A method according to claim 1, wherein the presence status of the user is determined from the aggregated presence status probabilities relating to a plurality of terminals of said user connected to said network, in such a manner as to determine the terminal at which the user has the greatest probability of being reachable.

5. A method according to claim 1, wherein said presence status information units are provided dynamically in response to the user being interrogated by at least one status source associated with a terminal of the user.

6. A system of updating a presence status of a user at at least one terminal connected to a telecommunications network, each terminal being associated with at least one status source for providing presence status information about said user, said system comprising a data aggregator device comprising:
collector means for collecting a plurality of unit presence probability values provided by a plurality of status sources associated with said terminal; and
calculator means for calculating an aggregated presence status probability resulting from a linear combination of said unit presence probability values.

7. A system according to claim 6, further comprising means for classifying the unit presence probability values in increasing order so as to form an ordered set of values for use in calculating the aggregated presence status probability.

8. A system according to claim 7, wherein said calculator means are adapted to calculate the aggregated presence status probability defined by P=Mₙ associated with said terminal by recurrence using the formula:
Mᵢ=Mᵢ₋₁+0.5×(Vᵢ−Mᵢ₋₁)
for all 1≦i≦n and with the initial condition M₀=0.5; where Vᵢ designates the i^{th} unit presence probability value taken in said ordered set, and n designates the last element of said ordered set.

9. A computer program including instructions for executing the steps of the method according to claim 1 when said program is executed by a computer.

10. A recording medium readable by a computer on which there is recorded a computer program comprising instructions for executing the steps of the method according to claim 1.
